(19) United States
(12) Patent Application Publication
(10) Pub. No.: US 2012/0146357 A1
(43) Pub. Date: Jun. 14, 2012

(54) ELECTRICALLY-OPERATED STORAGE ASSEMBLY FOR VEHICLES

(76) Inventor: Wen-Tse Huang, Kaohsiung (TW)

(21) Appl. No.: 12/968,263

(22) Filed: Dec. 14, 2010

(51) Int. Cl. B60J 3/00

(52) U.S. Cl. 296/97.6; 296/97.4

(57) ABSTRACT

An electrically-operated storage assembly for vehicles comprises a car visor, a sliding rail kit, two sliding blocks, a coupling piece, an electrical transmission component, a clamping apparatus, and an object. The car visor is disposed on the vehicle ceiling and has an interior space with an opening on one side of the car visor. The sliding rail kit includes two relatively parallel sliding bars. The two sliding blocks are respectively assembled to correspond to the sliding bars. On the sides of the two sliding blocks facing each other are assembling surfaces whereon radial teeth are disposed. The coupling piece connects the two sliding blocks. The electrical transmission component is fixedly joined to the coupling piece to drive it to move along the axis of the sliding bar. The clamping apparatus has an axial side and two lateral end surfaces, whereon are disposed axle seats to be respectively embedded in corresponding assembling surfaces of the sliding blocks. On the end surfaces of the axle seats are disposed radial teeth corresponding to those on the assembling surfaces of the sliding blocks. The object is disposed on the axial side of the clamping apparatus.

### BACKGROUND OF THE INVENTION

1. Field of the Invention

The present invention relates to an electrically-operated storage assembly for vehicles, and especially to a storage structure capable of electrically taking an object into a car visor for storage and electrically unfolding it for use.

2. Brief Description of the Related Art

Existing car visors are commonly disposed on a vehicles' front seat ceiling and their angles can be adjusted manually. They lie flatly against the vehicle ceiling when not in use for light shielding and can be adjusted to an appropriate angle to block direct sunlight when needed. However, since conventional car visors are made of opaque materials, when they are in use and cover a large area of vision driving safety is unavoidably undermined.

To solve the foregoing problem, some manufacturers dispose transparent light filtering plates on car visors. However, components thus assembled to car visors are exposed to the exterior thereof, a rather disagreeable sight particularly in luxury cars.

Further, objects which are most commonly stored inside car visors are transparent light filtering plates. Other objects such as 3C products have not yet been accommodated.

### SUMMARY OF THE INVENTION

In order to overcome the deficiencies of the prior art, a primary object of the present invention is to provide an assembly for vehicles which is capable of electrically taking an object into a car visor for storage and electrically unfolding it for use.

With the above object in mind, the present invention provides an electrically-operated storage assembly for vehicles, comprising a car visor, a sliding rail kit, two sliding blocks, a coupling piece, an electrical transmission component, a clamping apparatus, and an object. The car visor is disposed on a vehicle ceiling and has an interior space with an opening on a side of the car visor. The sliding rail kit includes two relatively parallel sliding bars. The two sliding blocks are respectively assembled to corresponding sliding bars. On the sides of the two sliding blocks facing each other there are assembling surfaces whereon radial teeth are disposed. The coupling piece connects the two sliding blocks. The electrical transmission component is fixedly joined to the coupling piece to drive it to move along the axis of the sliding bar. The clamping apparatus has an axial side and two lateral end surfaces, whereon are disposed axle seats to be respectively embedded in corresponding assembling surfaces of the sliding blocks. On the end surfaces of the axle seats are disposed radial teeth corresponding to those on the assembling surfaces of the sliding blocks. The object is disposed on the axial side of the clamping apparatus.

The electrical transmission component comprises a stepper motor with a transmission gear, a free gear, and a timing belt disposed between the transmission gear and the free gear. Both the stepper motor and the free gear are fixedly joined to the interior space of the car visor, and the timing belt is attached to the coupling piece.

The foregoing vehicle ceiling can be the ceiling above either the driver's seat or the second front seat.

On the far side of the object from the axial side of the clamping apparatus is disposed a flange for the object to be pulled.

The coupling piece and the two sliding blocks can be monolithically formed.

The benefit of the present invention is its capability of electrically taking the object (such as a transparent light filtering plate) into the interior space of the car visor and electrically unfolding it out of the car visor for use by controlling a switch disposed inside the vehicle. Taking a transparent light filtering plate as an example, it can be used to filter harsh light and improve visibility owing to its transparency. The design of the present invention allows the light filtering plate to be stored inside the opaque car visor and improve the interior design of the vehicle. Further, as the present invention unfolds the light filtering plate from one side of the car visor, the combination of the car visor and the light filtering plate provides a larger range of sunlight filtration and better fits users of different statures. On the other hand, besides taking in and unfolding light filtering plates, the present invention can also be applied to take in and unfold solar panels, tablet computers, GPS navigators, or liquid crystal displays.

### BRIEF DESCRIPTION OF THE INVENTION

The detailed structure, the applied principles, the functions and the effectiveness of the present invention can be more fully understood with reference to the following description and accompanying drawings, in which:

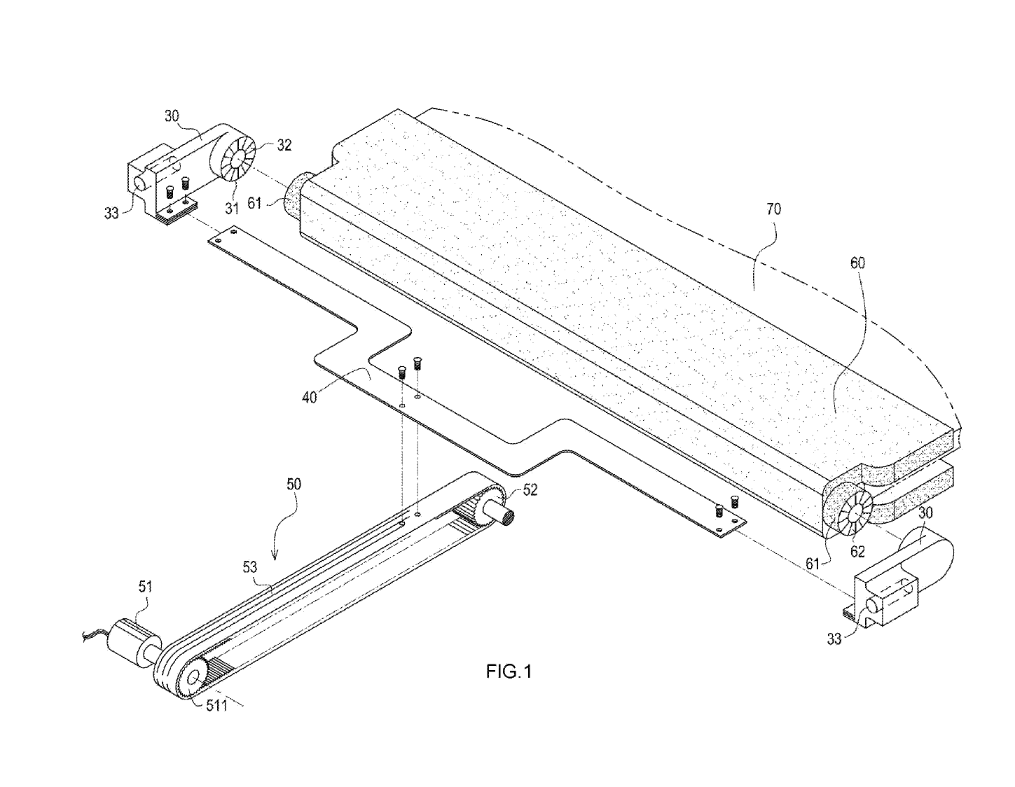

FIG. 1 is an exploded perspective view of an embodiment electrically-operated storage assembly for vehicles according to the present invention;

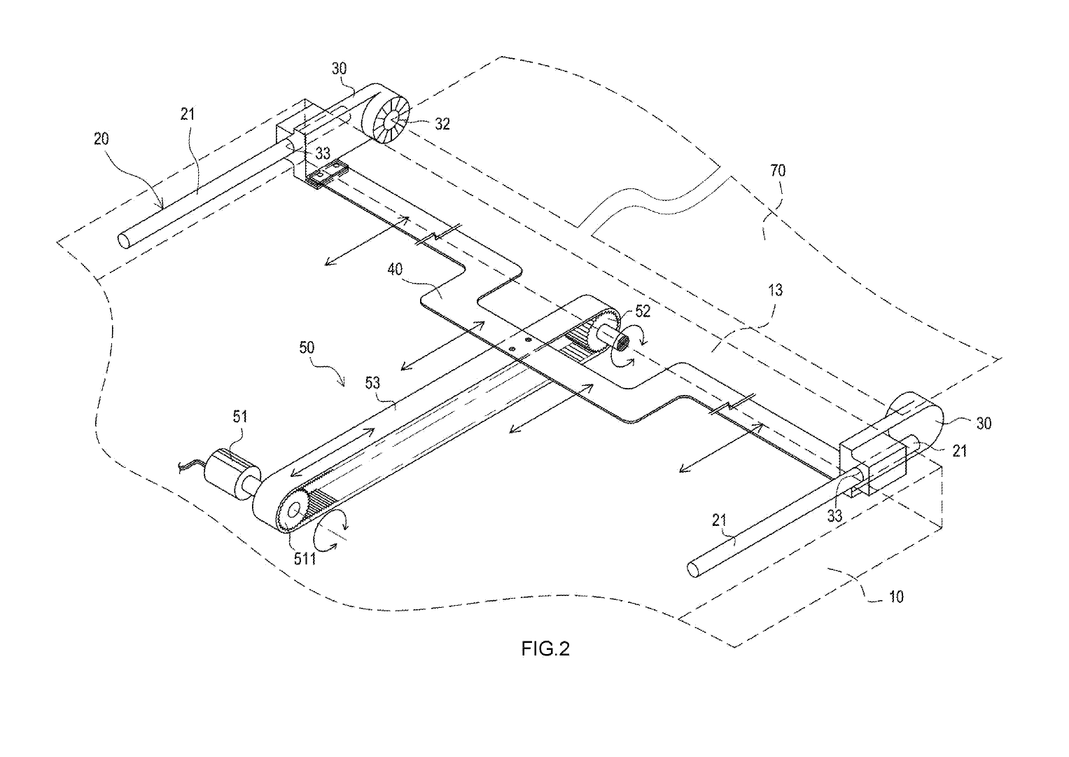

FIG. 2 is an assembled perspective view of an embodiment electrically-operated storage assembly for vehicles according to the present invention;

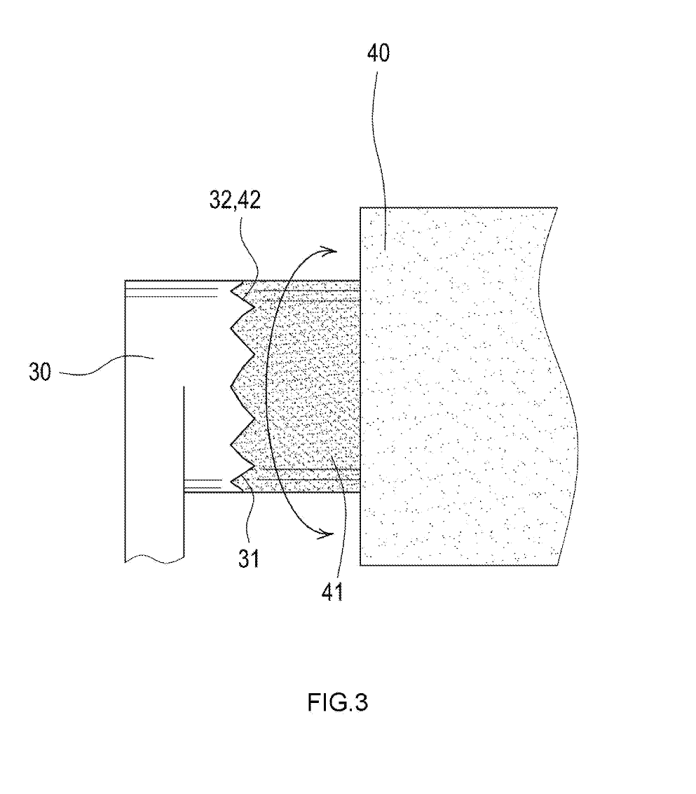

FIG. 3 is a schematic representation showing angular adjustment of an object in an electrically-operated storage assembly for vehicles according to a preferred embodiment of the present invention;

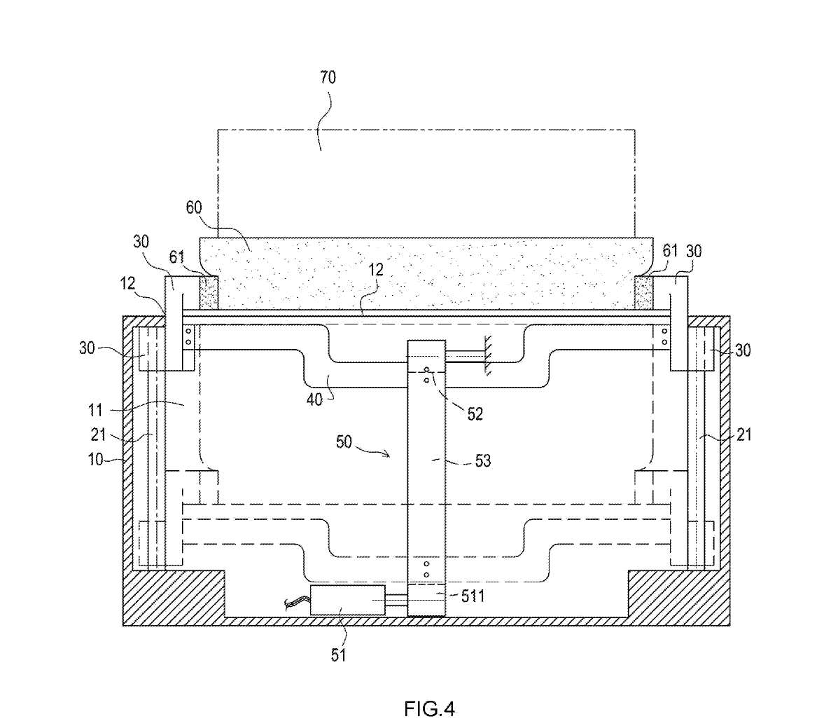

FIG. 4 is a top sectional view showing a car visor taking in and unfolding an object in an electrically-operated storage assembly for vehicles according to a preferred embodiment of the present invention;

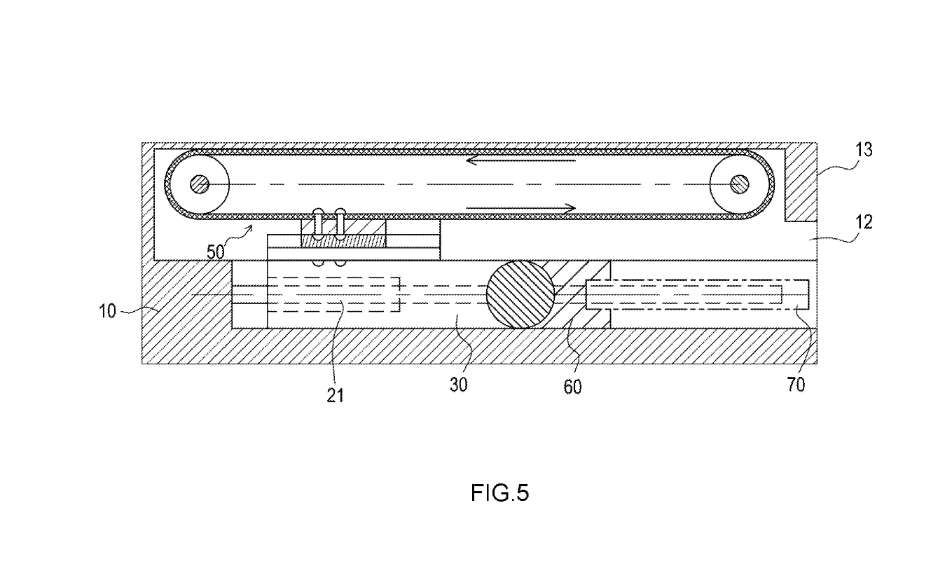

FIG. 5 is a side sectional view showing a car visor taking in an object in an electrically-operated storage assembly for vehicles according to a preferred embodiment of the present invention;

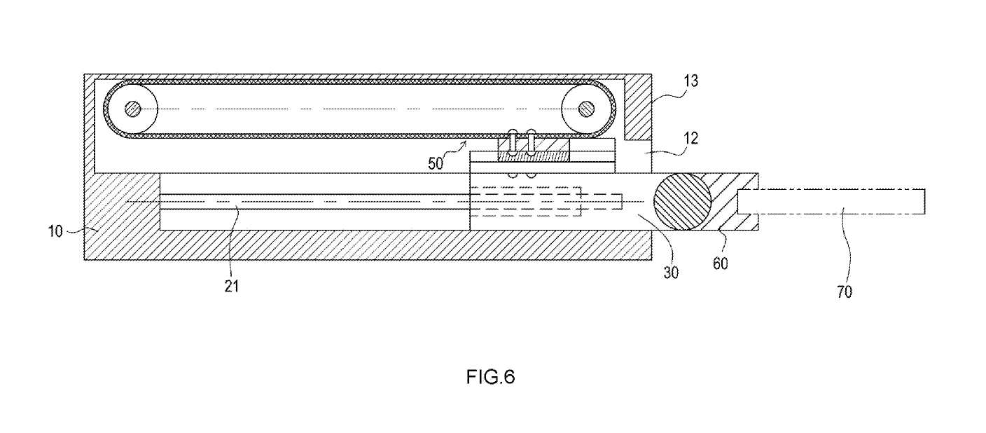

FIG. 6 is a side sectional view showing a car visor unfolding an object in an electrically-operated storage assembly for vehicles according to a preferred embodiment of the present invention;

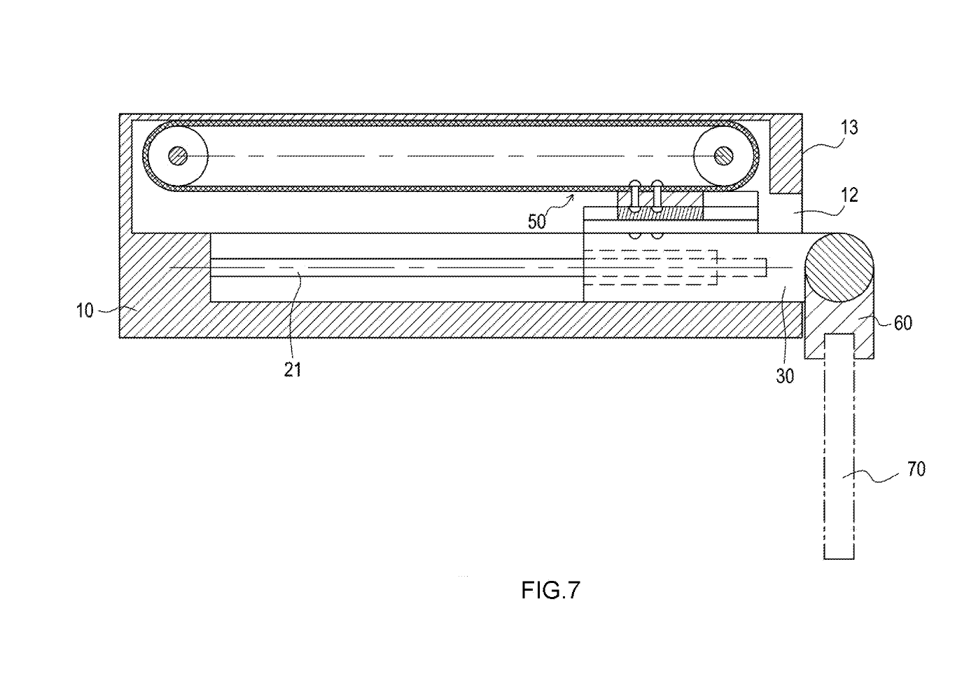

FIG. 7 is a schematic representation showing angular adjustment of the car visor shown in FIG. 6;

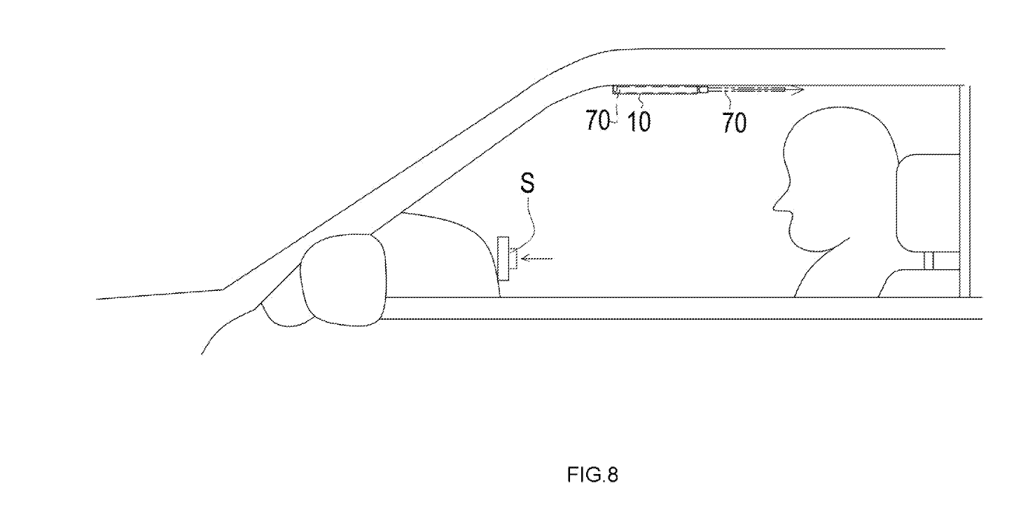

FIG. 8 is an application embodiment of the in-car installation and automatic unfolding of an electrically-operated storage assembly for vehicles according to a preferred embodiment of the present invention;

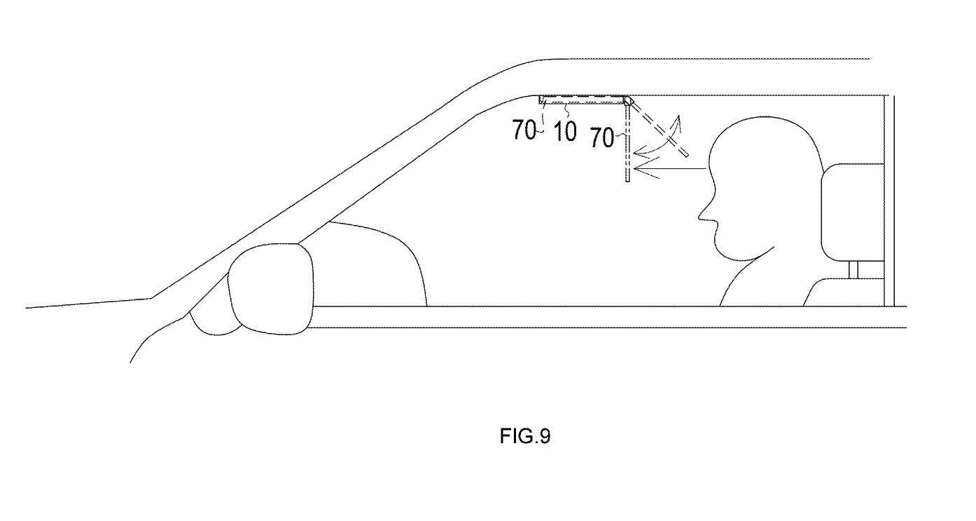

FIG. 9 is an application embodiment of an in-car installation of an electrically-operated storage assembly for vehicles according to a preferred embodiment of the present invention along with the angular adjustment of the car visor;

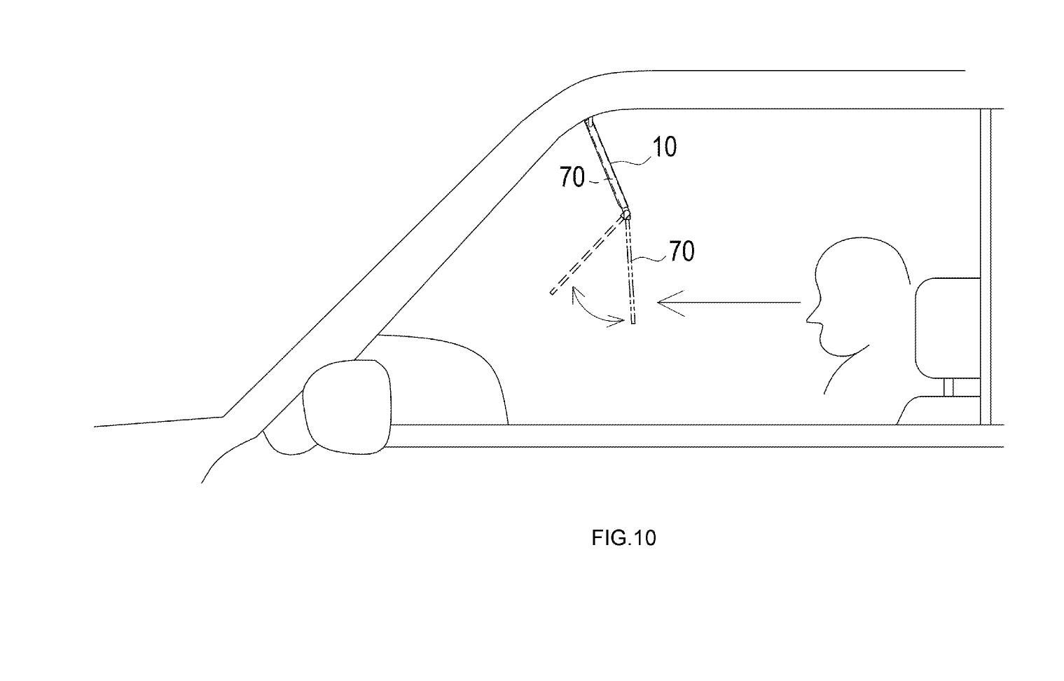

FIG. 10 is an application embodiment of the in-car installation of an electrically-operated storage assembly for vehicles according to a preferred embodiment of the present invention along with the angular adjustment of the car visor and the object;

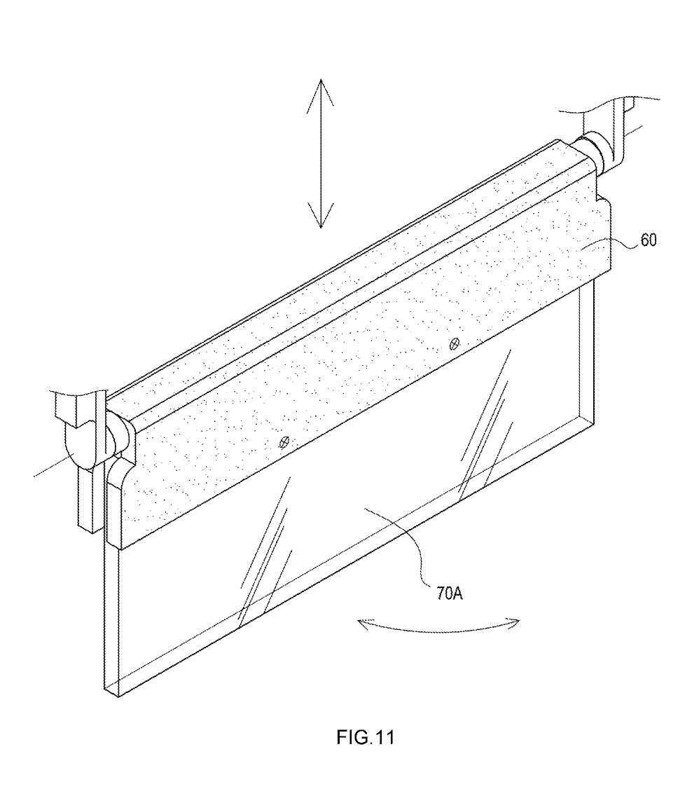

FIG. 11 is a perspective view showing a light filtering plate being clamped to an electrically-operated storage assembly for vehicles according to a preferred embodiment of the present invention;

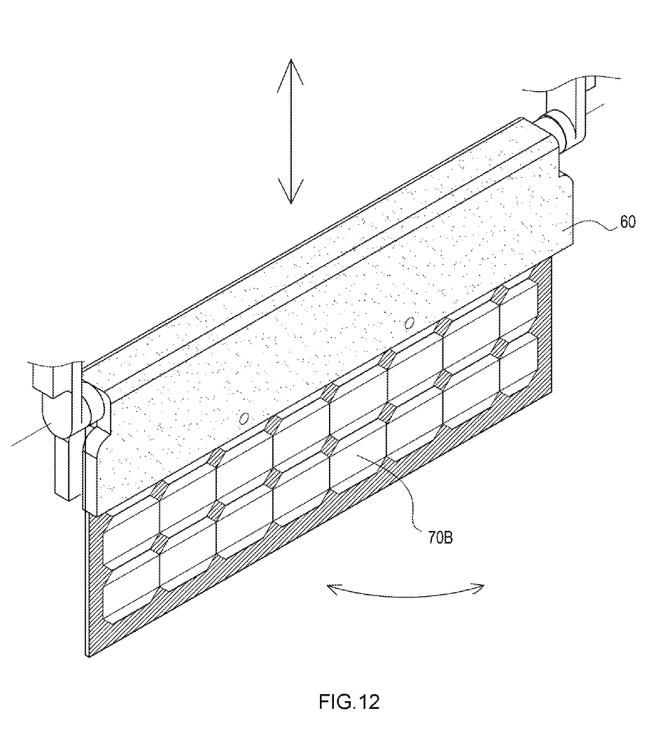

FIG. 12 is a perspective view showing a solar panel being clamped to an electrically-operated storage assembly for vehicles according to a preferred embodiment of the present invention;

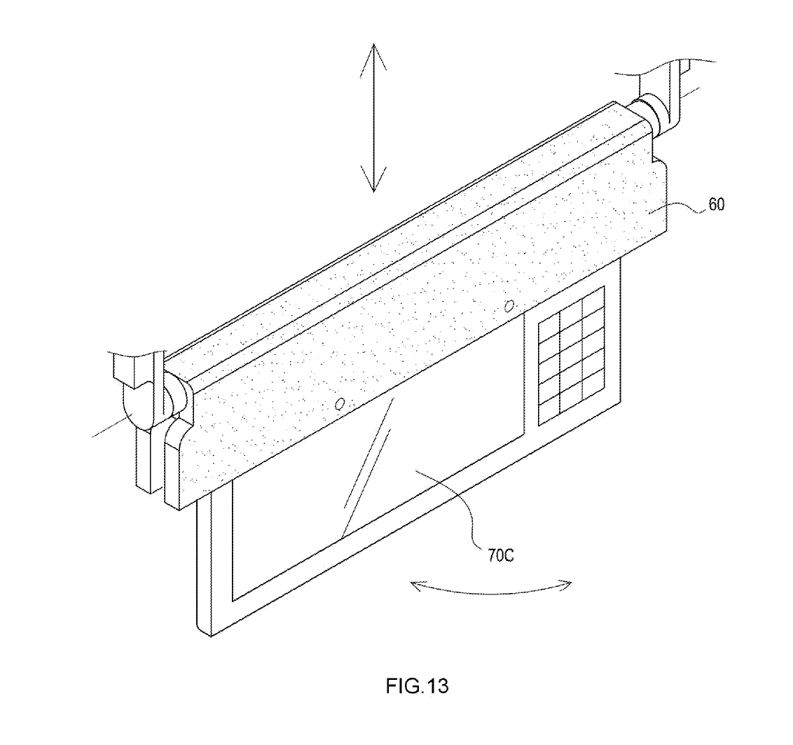

FIG. 13 is a perspective view showing a liquid crystal display being clamped to an electrically-operated storage assembly for vehicles according to a preferred embodiment of the present invention;

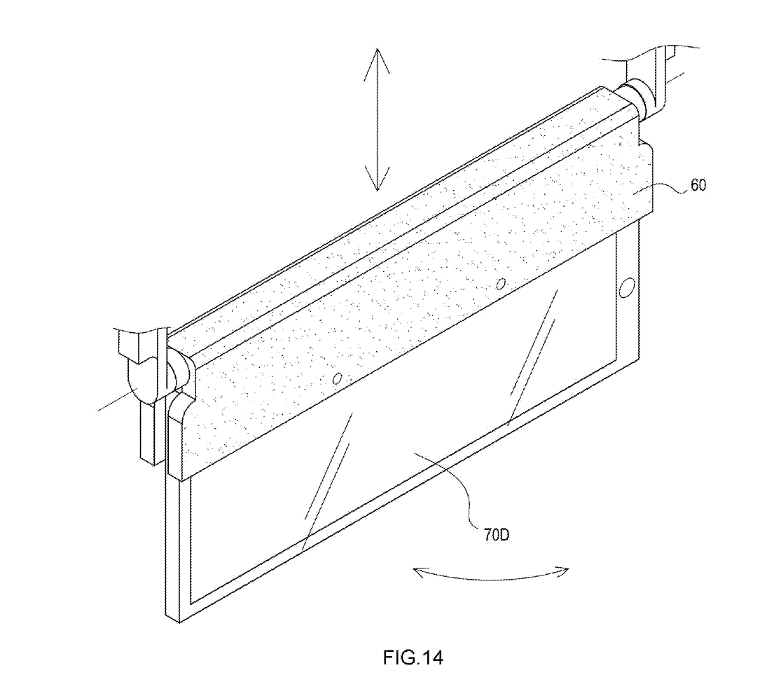

FIG. 14 is a perspective view showing a tablet computer being clamped to an electrically-operated storage assembly for vehicles according to a preferred embodiment of the present invention; and

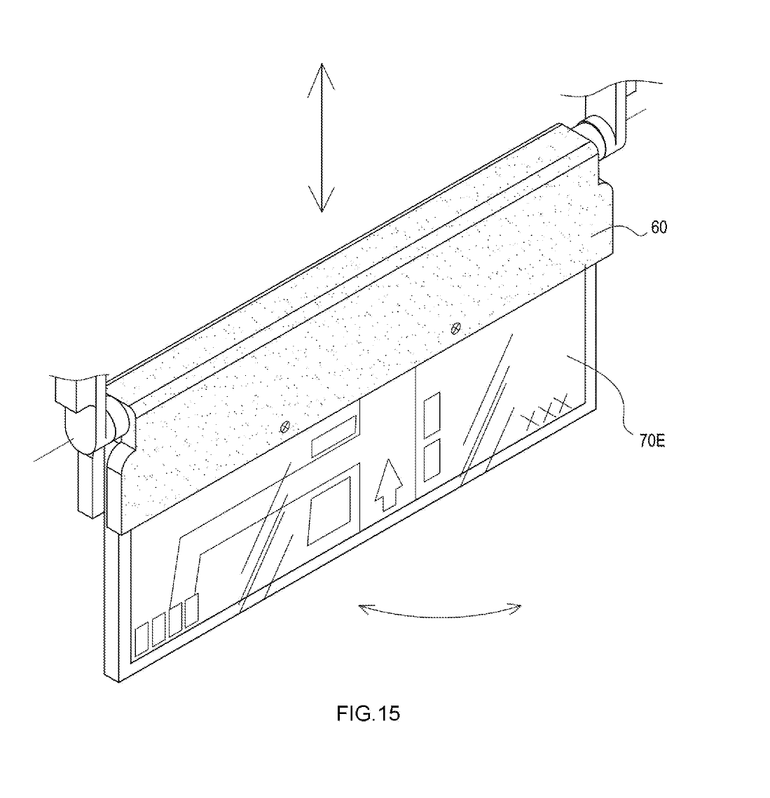

FIG. 15 is a perspective view showing a GPS navigator being clamped to an electrically-operated storage assembly for vehicles according to a preferred embodiment of the present invention.

### DETAILED DESCRIPTION OF THE PREFERRED EMBODIMENTS

The above and further objects and novel features of the invention will more fully appear from the following detailed description when the same is read in connection with the accompanying drawings. It is to be expressly understood, however, that the drawings are for purpose of illustration only and are not intended as a definition of the limits of the invention.

FIGS. 1, 2 and 3 illustrate a preferred embodiment of the present invention, wherein an object 70 is a light filtering plate 70A. The electrically-operated storage assembly for vehicles of the present invention comprises parts described hereinafter.

A car visor 10 is disposed on the vehicle ceiling and has an interior space 11 with an opening on one side 13 of the car visor 10.

A sliding rail kit 20 is disposed in the interior space 11 of the car visor 10 and includes two relatively parallel sliding bars 21.

Two sliding blocks 30 are respectively assembled to corresponding sliding bars 21. On the sides of the two sliding blocks 30 facing each other there are assembling surfaces 31 whereon radial teeth 32 are disposed.

A coupling piece 40 screw locks and connects the two sliding blocks 30.

An electrical transmission component 50 is fixedly joined to the coupling piece 40 by screw locking the two to drive it to move along the axis of the sliding bar 21.

A clamping apparatus 60 has an axial side and two lateral end surfaces, whereon are disposed axle seats 61 to be respectively embedded in corresponding assembling surfaces 31 of the sliding blocks 30. The axle seat 61 provides radial teeth 62 corresponding to the assembling surface 31. By pressing the axle seat 61 in between the assembling surfaces 31 of the two sliding blocks 30, the two radial teeth 32 and 62 are meshed with each other thereof, allowing the clamping apparatus 60 to form a blocking and supporting force between the sliding blocks 30, and therefore being able to adjust the clamping apparatus 60 section-by-section by using the meshed radial tooth 32 and 62.

An object 70A is disposed on the axial side of the clamping apparatus 60.

The coupling piece 40 and the two sliding blocks 30 can be monolithically formed together without needing to screw them together.

The electrical transmission component 50 comprises a stepper motor 51 with a transmission gear 511, a free gear 52, and a timing belt 53 disposed between the transmission gear 511 and the free gear 52. Both the stepper motor 51 and the free gear 52 are fixedly joined to the interior space 11 of the car visor 10, and the timing belt 53 is attached to the coupling piece 40. Further, the stepper motor 51 is coupled to the vehicle electrical system (not illustrated), which by using a switch S (as shown in FIG. 8) it is capable of actuating the stepper motor 51 to rotate clockwise and unfold the object 70 or to rotate counterclockwise to take the object 70 into the interior space 11 of the car visor 10.

Referring to FIGS. 4-7, the precise position of the object 70 can be determined and controlled by the stepper motor 51.

The foregoing vehicle ceiling can be the ceiling above the driver's seat or the second front seat.

As the object 70 according to the present invention can be a light filtering plate 70A, it can be used to filter harsh light and improve visibility owing to its transparency. The design of the present invention allows the light filtering plate 70A to be stored inside the opaque car visor 10 and improve the interior design of the vehicle. Further, as the present invention unfolds the light filtering plate 70A from one side of the car visor 10, the combination of the car visor 10 and the light filtering plate 70A provides a larger range of sunlight filtration and better fits users of different statures, as shown in FIGS. 9 and 10.

Referring to FIGS. 11-15, besides taking in and unfolding the light filtering plate 70A (illustrated in FIG. 11) described above, the present invention can also be applied to take in and unfold solar panel 70B (as shown in FIG. 12) for conversion of light energy into electricity, a liquid crystal display 70C (as shown in FIG. 13) for watching television, a tablet computer 70D (as shown in FIG. 14) for surfing the internet, and a GPS device 70E (as shown in FIG. 15) for navigation purposes by using the clamping apparatus 60. Screws or other locking components can be applied to the clamping apparatus 60 to strengthen the binding force if the object is too heavy.

A distinguishing feature of the present invention is the capability of electrically taking the object 70 into the interior space 11 of the car visor 10 for storage and electrically unfolding it out of the interior space 11 of the car visor 10 for use by controlling the switch S disposed inside the vehicle. Take transparent light filtering plate 70A as an example. The transparent light filtering plate 70A can be used to filter harsh light and improve visibility owing to its transparency. The design of the present invention allows the light filtering plate 70A to be stored inside the opaque car visor 10 and improve the interior design of the vehicle. Further, as the present invention unfolds the light filtering plate 70A from one side of the car visor 10, the combination of the car visor 10 and the light filtering plate 70A provides a larger range of sunlight filtration and better fits users of different statures. On the other hand, the present invention can also be applied to solar panels, tablet computers, GPS navigators, or liquid crystal displays.

While the invention has been described with reference to a preferred embodiment thereof, it is to be understood that modifications or variations may be easily made without departing from the spirit of this invention, which is defined in the appended claims.

What is claimed is:

1. An electrically-operated storage assembly for a vehicle, comprising:
a car visor disposed on the vehicle ceiling and having an interior space with an opening on a side of the car visor;
a sliding rail kit includes at least two relatively parallel sliding bars disposed in the interior space of the car visor;
at least two sliding blocks respectively assembled to correspond to the sliding bars, wherein on the sides of the sliding blocks facing each other there are assembling surfaces whereon radial teeth are disposed;
a coupling piece connecting the at least two sliding blocks;
an electrical transmission component coupled to the coupling piece, whereby to drive the coupling piece to move along the axis of the sliding bar;
a clamping apparatus with an axial side and at least two lateral end surfaces, whereon are disposed axle seats to be respectively embedded in corresponding assembling surfaces of the sliding blocks, and wherein on end surfaces of the axle seats are disposed radial teeth corresponding to those on the assembling surfaces of the sliding blocks; and
an object disposed on the axial side of the clamping apparatus.

2. An electrically-operated storage assembly for a vehicle as defined in claim 1, wherein the electrical transmission component comprises:
a stepper motor with a transmission gear fixedly joined to the interior space of the car visor;
a free gear fixedly joined to the interior space of the car visor; and
a timing belt disposed between the transmission gear and the free gear and attached to the coupling piece.

3. An electrically-operated storage assembly for vehicles as defined in claim 1, wherein the coupling piece and the at least two sliding blocks are monolithically formed.

4. An electrically-operated storage assembly for vehicles as defined in claim 2, wherein the coupling piece and the at least two sliding blocks are monolithically formed.

5. An electrically-operated storage assembly for vehicles as defined in claim 1, wherein the vehicle ceiling is disposed above the driver's seat.

6. An electrically-operated storage assembly for vehicles as defined in claim 2, wherein the vehicle ceiling is disposed above the driver's seat.

7. An electrically-operated storage assembly for vehicles as defined in claim 1, wherein the vehicle ceiling is disposed above a second front seat.

8. An electrically-operated storage assembly for vehicles as defined in claim 2, wherein the vehicle ceiling is disposed above a second front seat.

9. An electrically-operated storage assembly for vehicles as defined in claim 1, wherein the object is a light filtering plate.

10. An electrically-operated storage assembly for vehicles as defined in claim 1, wherein the object is a solar panel.

11. An electrically-operated storage assembly for vehicles as defined in claim 1, wherein the object is a liquid crystal display.

12. An electrically-operated storage assembly for vehicles as defined in claim 1, wherein the object is a tablet computer.

13. An electrically-operated storage assembly for vehicles as defined in claim 1, wherein the object is a GPS navigation system.
